(19) United States
(12) Patent Application Publication
(10) Pub. No.: US 2026/0312520 A1
(43) Pub. Date: Oct. 8, 2026

(54) METHOD AND ARRANGEMENT FOR ENERGY-AWARE DEAD-TIME INSERTION

(71) Applicant: Silicon Mobility SAS, Valbonne (FR)

(72) Inventors: Eric MINIERE, Valbonne (FR); Farid TAHIRI, Valbonne (FR); Khaled DOUZANE, Grasse (FR)

(21) Appl. No.: 19/483,243

(22) PCT Filed: Jul. 12, 2023
(86) PCT No.: PCT/EP2023/069387

§ 371 Date: Nov. 11, 2025

(51) Int. Cl. H02P 21/22; H02P 6/10; H02P 6/12

(52) U.S. Cl. CPC H02P 21/22; H02P 6/10; H02P 6/12

(57) ABSTRACT

A method for improved energy injection to an electric motor, including: (i) receiving transistor gate signals for at least one set of serially connected transistors; (ii) determining, for said transistors, which transistors will inject energy to the motor and which transistors not; and (iii) (a) providing to said transistors which shall inject energy to the motor, the transistor gate signal as is; and (b) providing to the other transistors the transistor gate signal with dead-time compensation; and (iv) returning to step (i).

### CROSS-REFERENCE TO RELATED APPLICATION(S)

This application is a national phase of International Application No. PCT/EP2023/069387 filed on Jul. 12, 2023, the entire contents of which are incorporated herein by reference.

### FIELD OF THE INVENTION

This invention applies in the context of electric machine digital control algorithm using inverter power stage. It is related to the control of the transistor of such inverters and more particularly on the respect of the deadtime constraint.

### BACKGROUND OF THE INVENTION

FIG. 1A shows a typical digital controlled electric motor system. In an inverter topology, the control needs to drive the transistor at the high side and at the low side in a opposite manner. FIG. 1B shows the multi-level alternative. When the high side is driven a high level, then the low side is driven a low level. Ideally the 2 transistors are driven simultaneously, but at the transistor point of view, it takes time to switch from 0 to VBAT or VBAT to 0. Therefore, the rising and falling time characterize the deadtime which is a time where the transistor is in a switching state. This time shall be considered in the control to avoid transistor short cut.

In essence, the dead-time insertion is applied on transistor control in a systematic manner. This means that the resulting modification of control waveform is not the result of the digital controller that computes the waveform to inject the exact energy to the motor. In other words, the dead-time insertion reduces the energy flow to the motor and also disturbs the sinus waveform on e-motor coils.

FIG. 2 demonstrates this problem. The original pulse computed by the digital modulation algorithm is shorter in reality because of dead-time insertion. Therefore, the digital control computation must be adjusted to anticipate the dead-time effect and apply the expected energy to the motor, this is called deadtime compensation.

On inverters controlled with PWM (Pulse Width Modulation), the strategy is well known, it consists in adjusting the modulation duty cycle to add the dead-time delay. The deadtime compensation using duty cycle cannot be used for modulation not based on duty cycle. This is the case for pattern-based modulation where inverter control signals are pre-defined for each energy operating point.

### SUMMARY OF THE INVENTION

The invention aims to have a solution which is independent of the modulation.

The invention further aims for a solution which respects the deadtime without energy loss such that it is not needed to be compensated.

The invention relates to a method for improved energy injection to an electric motor, comprising the steps of: (i) receiving transistor gate signals for at least one serially connected transistor pair; (ii) determining, for said transistor pair, which transistor shall inject energy to the motor and which transistor not; and (iii) (a) provide to said transistor which shall inject energy to the motor, the transistor gate signal as is and (b) provide to the other transistor the transistor gate signal with dead-time compensation; and (iv) return to step (i).

In embodiment of the invention said determining, for said transistor pair, which transistor shall inject energy to the motor and which transistor not, is based on information determined from the motor, preferably the direction of the current flow.

In a further embodiment of the invention, said determining, for said transistor pair, which transistor shall inject energy to the motor and which transistor not, is based on measuring (the direction of) the current flow.

In an alternative further embodiment, said determining, for said transistor pair, which transistor shall inject energy to the motor and which transistor not, is based on estimating (the direction of) the current flow from information provided by the modulation method used for determining the received transistor gate signals.

In yet a further embodiment a difference in the determination as done via estimation or measurement is used to indicated safety issues, in particular a difference in the determined direction between the estimated and measurement direction of the current flow is used to indicate safety issues.

This invention provides phase current drive dead-time insertion in the context of electric machine digital control algorithm using ‘inverter’power stage.

The key of the innovation is to focus on energy flow through power stage transistors. And, more specifically on which of those transistors the electric energy is injected to the motor.

FIG. 4 shows the six operating states on each phase of the inverter circuit and the associated energy injection characteristics. In summary only two configurations are actually injecting energy to the motor:
“upper” transistor passing with positive current
“lower” transistor passing with negative current

The inverter modulation algorithm is designed so that it optimizes the energy injection to the motor to reach expected speed/torque operating point with best efficiency. Therefore, it is necessary and sufficient to respect the period of inverter power stage transistors activations that corresponds to one of the two previous situations when inserting dead-time period. Any other activation periods may be disturbed without impact on inverter control efficiency.

FIGS. 5 and 8 illustrates the architecture of the modified inverter control.

In a first aspect of the invention a method is provided for improved energy injection to an electric motor, comprising the steps of: (i) receiving transistor gate signals for at least one serially connected transistor pair; (ii) determining, for said transistor pair, which transistor shall inject energy to the motor and which transistor not; and (iii) (a) provide to said transistor which shall inject energy to the motor, the transistor gate signal as is and (b) provide to the other transistor the transistor gate signal with dead-time compensation; and (iv) return to step (i).

In a second aspect of the invention an arrangement, comprising: (i) a digital logic circuit, generating transistor gate signals in accordance with a modulation method; (ii) a system, receiving said generated transistor gate signals as input and outputting transistor gate signals; (iii) an inverter and (iv) motor controlled by said inverter, being controlled by the by the system outputted transistor gate signals, characterized in that said system receiving information determined from the motor, characterized in that said system (a) provide to the transistor of a transistor pair within said inverter which shall inject energy to the motor, the transistor gate signal as is and (b) provide to the other transistor of said transistor pair the transistor gate signal with dead-time compensation.

In an embodiment thereof sensor circuitry to measure either current or current direction is provided and said circuitry provides said information.

In an alternative realization of the invention the arrangements comprises (i) a digital logic circuit, generating transistor gate signals in accordance with a modulation method; (ii) an inverter and (iii) motor controlled by said inverter, characterized in that said arrangement being adapted to (a) provide to the transistor of a transistor pair within said inverter which shall inject energy to the motor, the transistor gate signal as is and (b) provide to the other transistor of said transistor pair the transistor gate signal with dead-time compensation.

In an embodiment thereof, it is the digital circuit itself performing (a) and (b).

### BRIEF DESCRIPTION OF THE DRAWINGS

FIGS. 1A and 1B show a prior-art arrangement;

FIGS. 2 and 3 show typical signal handling in accordance with the methods in the art.

FIG. 4 illustrates the energy to the motor analysis that gives rise to the invention.

FIG. 5 shows an arrangement in accordance with the invention

FIGS. 6 and 7 are showing the behavior of the dead-time insertion logic on each inverter phase.

FIG. 8 shows (top and bottom) alternative arrangements in accordance with the invention.

FIG. 9 shows a modulation arrangement in accordance with the invention.

### DETAILED DESCRIPTION

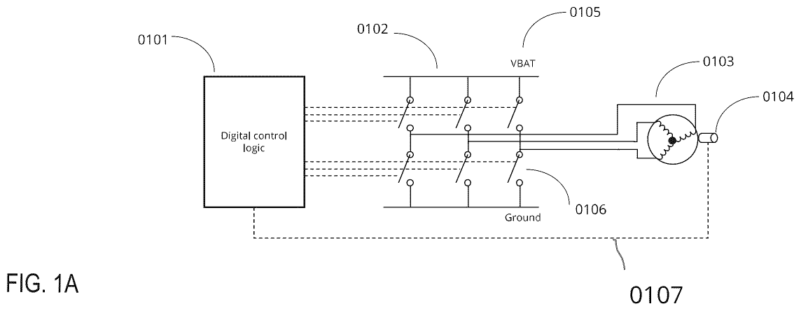

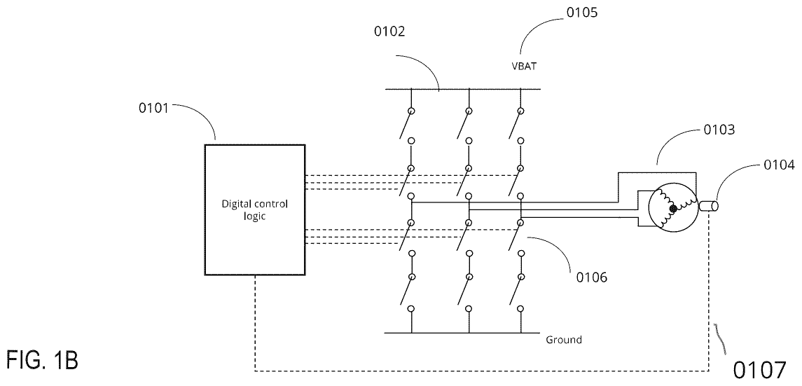

It is worth noting that while the embodiments of the invention are described with a 2-level inverter (FIG. 1: 2 transistors per legs which form a transistor pair) the innovation also applies to multi-level inverter (FIG. 1A: more than 2 transistors per leg), more in particular one will (a) provide to said transistors side (e.g upper or lower side) of the leg which shall inject energy to the motor, the transistor gate signal as is and (b) provide to the transistors in the different side (e.g upper or lower side)the transistor gate signal with dead-time compensation; and (iv) return to step (i).

Electric motors typically have a plurality of so-called phases, whereby with each phase a serially connected transistor pair is associated (and actually connected to coils in the motor, whereby the coils of those phases are placed apart in space), in reality at minimum 3 phases are present. Hence methods for improved energy injection to an electric motor will typically be applied also to a plurality of those phases and most likely to all phases. It will also apply to a plurality of transistors per leg.

The method for improved energy injection to an electric motor is applied to a rotating motor and is hence part of a dynamic process, more precisely the current direction is a dynamic information that periodically changes according to the electric motor angular position, and hence the method is applied repetitively, actually in sync with the rotation of the motor, in that once applied to the presently actively transistor pair (or related coils) the method will be applied to the next one (meaning the one coming active thereafter).

The invention provides for a method for improved energy injection to an (digitally controlled) electric motor, comprising the steps of: (i) receiving transistor gate signals for at least one serially connected transistor pair (which are part of an inverter and used to control a phase of said motor); (ii) determining, for said transistor pair, which transistor shall inject energy to the motor and which transistor not; and (iii) (a) provide to said transistor which shall inject energy to the motor, the transistor gate signal ‘as is’ (except for the delay cause by the required circuitry) and (b) provide to the other transistor the transistor gate signal ‘with dead-time compensation’ (relative to the delay cause by the required circuitry); and (iv) return to step (i) (for the next serially connected transistor pair).

In an embodiment of the invention, one provides that said determining, for said transistor pair, which transistor shall inject energy to the motor and which transistor not being based on information determined from the motor (closed loop) (directly and/or indirectly).

In a further embodiment thereof, one provides that said determining, for said transistor pair, which transistor shall inject energy to the motor and which transistor not being based on measuring the direction of the current flow from said phase.

In an alternative embodiment, one provides that said determining, for said transistor pair, which transistor shall inject energy to the motor and which transistor not being based on estimating the direction of the current flow from said phase from information provided by the modulation method used for determining the received transistor gate signals.

In a further embodiment it is proposed that ((once time) prior to (i)) selecting whether said determining being based on selecting either the measuring or estimating approach (based on (received) information about the reliability of the measurements of the direction of the current flow).

In yet another embodiment (which can be provided with the one above) it is proposed that difference in the determined direction between the estimated and measurement direction of the current flow is used to indicate safety issues.

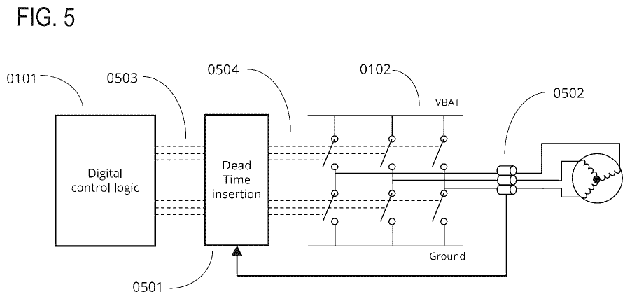

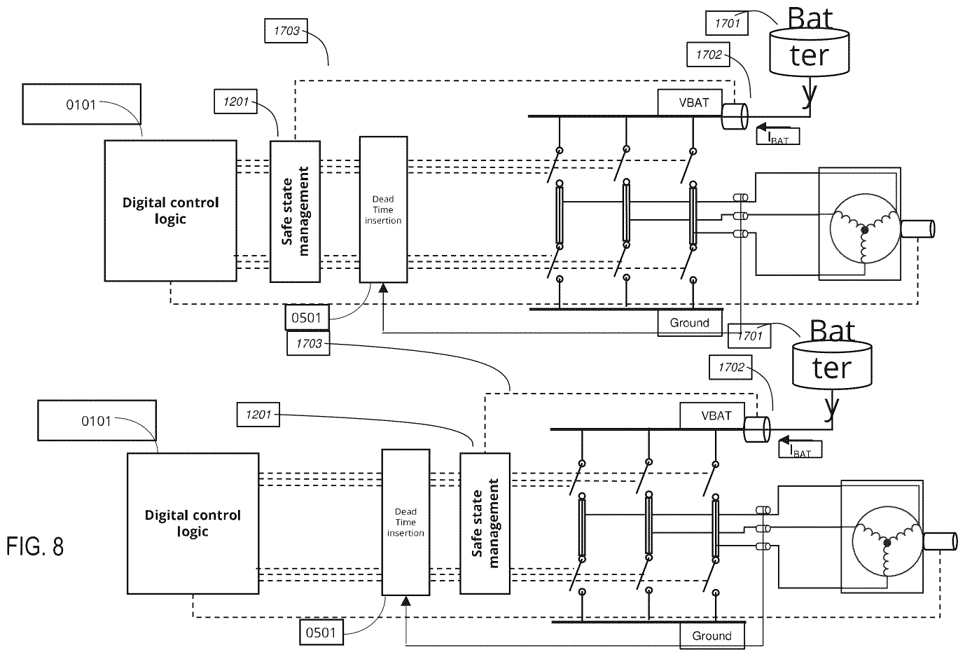

The invention provides an arrangement, comprising: (i) a digital logic circuit, generating transistor gate signals in accordance with a modulation method; (ii) a system, receiving said generated transistor gate signals as input and outputting transistor gate signals; (iii) an inverter and (iv) motor controlled by said inverter, being (directly as shown in FIG. 5 or indirectly if there is an intermediate additional system as shown in FIG. 8) controlled by the by the system outputted transistor gate signals, characterized in that said system receiving information determined from the motor (closed loop) (directly or indirectly via said digital logic circuit), characterized in that said system (a) provide to the transistor of a transistor pair within said inverter which shall inject energy to the motor, the transistor gate signal as is and (b) provide to the other transistor of said transistor pair the transistor gate signal with dead-time compensation.

In an embodiment of the invention the arrangement comprises sensor circuitry (0502) to measure phase currents including its direction is provided and said circuitry provides said information (preferably low pass filters are applied to the current measurements).

In an alternative embodiment (combinable with the previous embodiment) said information is provided by said digital logic circuit.

In a further embodiment the arrangement comprises an analog-to-digital convertor to digitize said information from the sensor circuitry (in particular said current direction measurements). In an exemplary embodiment of the invention, one current direction measurement per phase is provided. In an alternative embodiment, since also measurements (1703) on the battery or ground line can be performed (especially in case where additional systems are used using such measurements as shown in FIG. 8), which in essence are an average of the currents of all phases, one could such those measurements, so one may fairly state that current direction measurements per phase except one can be used in combination with the battery or ground measurements. In a further alternative embodiment though, to provide a high-end solution and to combat current measure uncertainly, one can still use current direction measurement per phase in addition with the battery or ground measurements, for instance applying techniques based on over dimensioned set of equations.

FIG. 1 shows a prior-art arrangement, comprising: a digital logic circuit (0101), generating transistor gate signals, an inverter (0102) and motor (0103) controlled by said inverter, said inverter being controlled by the transistor gate signals, characterized in that said digital logic circuit is receiving information (e.g. related to motor velocity) determined from the motor (closed loop) control.

More in particular in FIG. 1 one finds a schematic on a typical digital controlled electric motor system comprising:
0101: The digital control system
0102: The electric motor power stage (aka: Inverter)
0103: The electric motor (here is an example with 3 phases, there may be more phases)
0104: The motor position sensor system
0105: The vehicle battery power line
0106: The transistors controlled by the digital logic

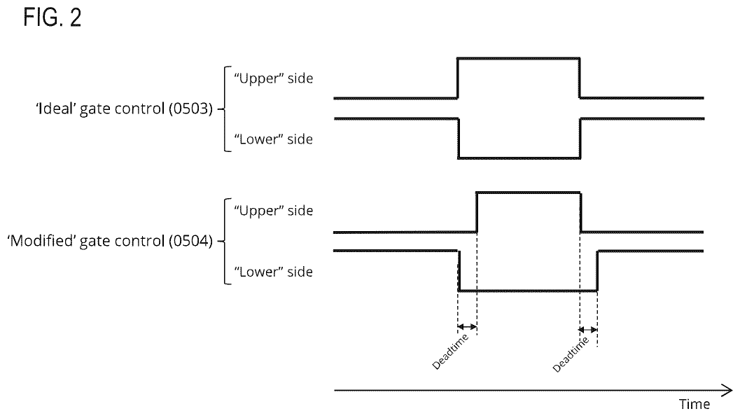

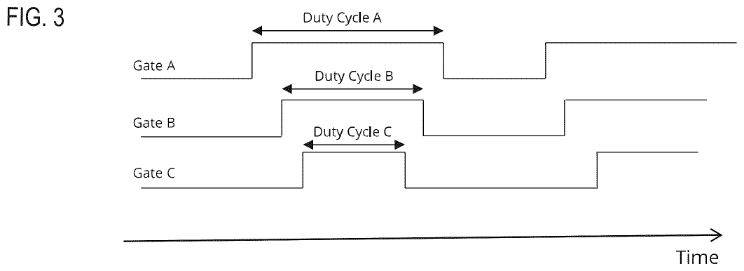

FIGS. 2 and 3 show typical signal handling in accordance with the methods in the art, in particular in FIG. 2 a typical deadtime insertion and in FIG. 3 an example of a PWM gate control using duty cycle.

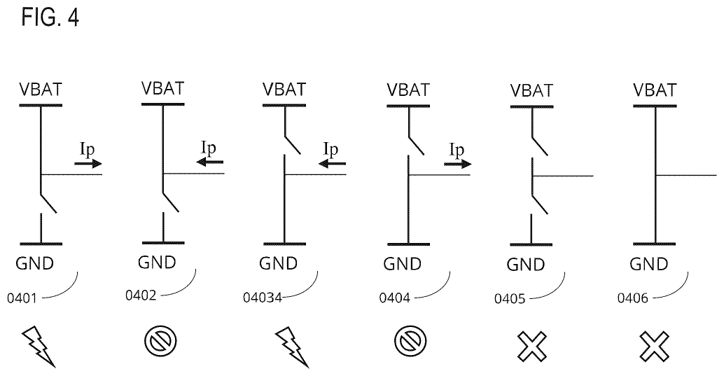

FIG. 4 illustrates the energy to the motor analysis that gives rise to the invention, more in particular, the inverter phase energy flow versus transistors state on inverter phase.

FIG. 5 shows an arrangement, comprising: a digital logic circuit (0101), generating transistor gate signals, the invented (so-called dead time insertion with compensation) system (0501), receiving said generated transistor gate signals (0503) as input and outputting transistor gate signals (0504), an inverter (0102) and motor (0103) controlled by said inverter, said inverter being controlled by the transistor gate signals, characterized in that said system is receiving information (e.g. current (direction) information) determined from the motor (closed loop) control (in addition to said digital logic circuit receiving other information (e.g. related to motor velocity) determined from the motor (closed loop) control-not shown)).

FIG. 5 illustrates the motor phase current direction driven dead-time insertion
(0501): An additional logic function is added between the digital control of inverter power stage and the inverter itself. This role of this logic is to modify the inverter ‘gate’ control signals so that dead-time is inserted without energy loss on motor control. The dead time is compensated.
(0502): This logic requires the current measure of each phase of the motor. More specification, it is the direction of the current that is actually useful.
(0503): The ‘ideal’ invert gate signals from modulation algorithm, without any dead-time.
(0504): The modified gate signals with dead-time inserted.

The dead-time insertion with compensation is working on each of the three phases independently. (note that this could also apply to inverters with more than 3 phases).

The dead-time insertion logic is operating such as the gate signal that drives the transistor currently injecting energy to the motor is transmitted “as is” to the transistor. And, the other gate signal of the same phase is modified to properly insert dead-time.

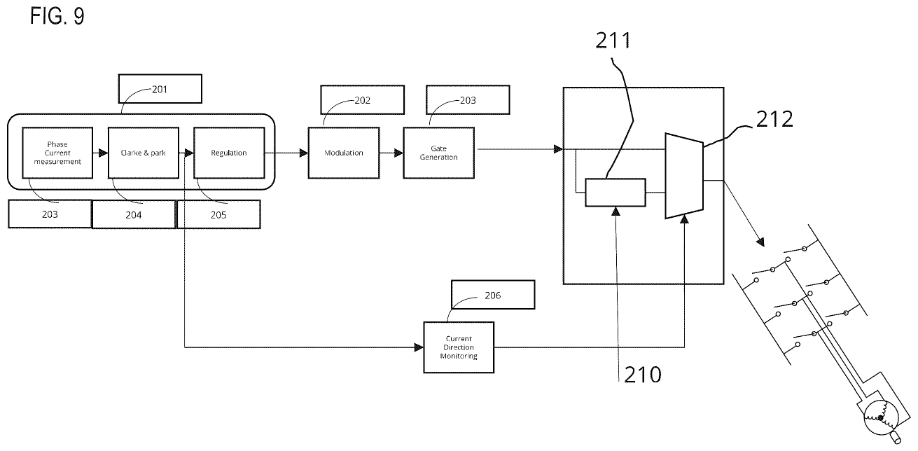

FIG. 9 illustrates the digital control that comprises:
(0201): Field oriented control (FOC) function. This stage is common to any modulation algorithm. Its role is to provides an information about the current angular positions of the motor and the difference between the actual and target operating point.
(0202): Modulation algorithm that interprets the information from FOC stage and compute the necessary power stage switch digital commands that are applied to power stage transistor gates.
(0203): Electric motor phase current measurement stage. This is typically a set of analog to digital converters (ADC) that gives accurate information about current motor state.
(0204): Clarke and Park transform function to convert tri-dimensional motor phase information into dual-dimensional Id/Iq information.
(0205): Regulation of Id/Iq information. This is typically done with a proportional/Integral digital filtering stage.
(0206): Current direction monitoring. This block determines from id/iq quadrant the current sign of each leg of the inverter to determine if the energy flow either on the transistor low side or high side.

In FIG. 9 also a possible implementation of the system or additional block or device is disclosed, comprising: (i) an input for a receiving transistor gate signal; (ii) an input of a control signal (206), indicating whether the related transistor shall inject energy to a motor or not; (iii) circuitry (211) for adding a delay to a signal (said circuitry can be a delay line but also a counter, which has a input line for providing the programmable delay (210)), said circuitry being connected said input; and (iv) a selector for selecting either said input or the output of said circuitry, based on said control signal.

The device, wherein said selector being a demultiplexer (212).

Note that the invention also pertains to systems, comprising a plurality of the devices described above at least one device per transistor of a serially connected transistor pair (which are part of an inverter and used to control a phase of a motor), preferably two devices for each of a plurality of phases, preferably all phases.

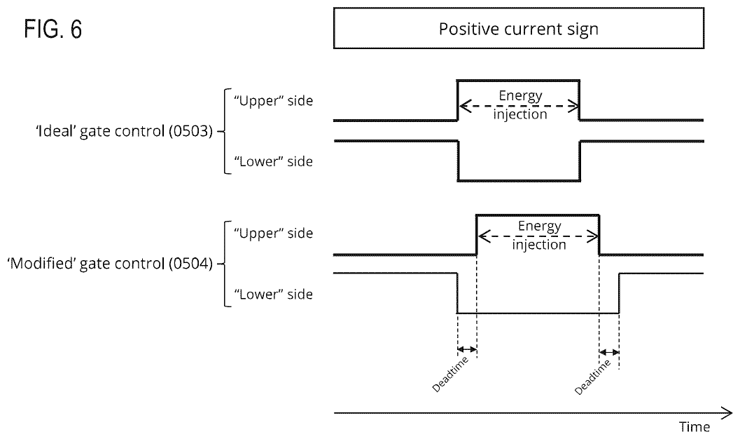

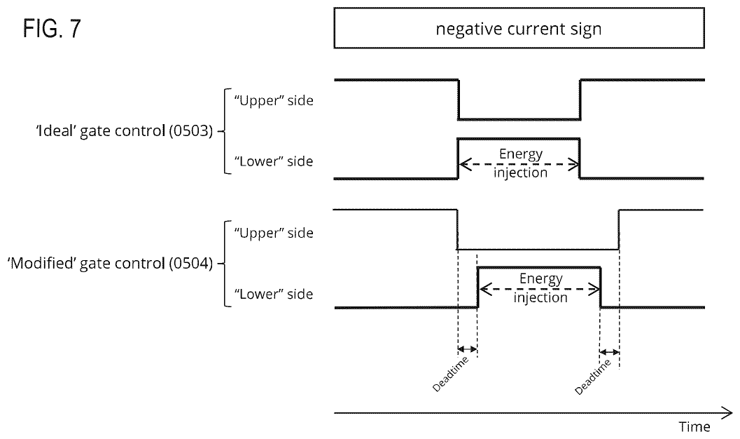

FIGS. 6 and 7 are showing the behavior of the dead-time insertion logic on each inverter phase.

FIGS. 6 and 7 show typical signal handling in accordance with the methods in accordance with the invention.

FIG. 8 shows (top and bottom) an arrangement, comprising: a digital logic circuit (0101), generating transistor gate signals, the invented (so-called dead time insertion with compensation) system (0501), receiving said generated transistor gate signals (0503) as input and outputting transistor gate signals (0504), an inverter (0102) and motor (0103) controlled by said inverter, said inverter being controlled by the transistor gate signals, characterized in that said system is receiving information determined from the motor (closed loop) control (in addition to said digital logic circuit receiving other information (e.g. related to motor velocity) determined from the motor (closed loop) control—here shown)), wherein additional systems (1021) (here denoted safe state management managing e;g a motor position sensor failure containment) are placed in between said digital logic circuit and said inverter, either before (top) or after (bottom) the invented (so-called dead time insertion) system, said safe state management additional system may get receive yet another type of information (e.g. current flow from the battery, current level of the motor phase, voltage phases . . . ).

In reality, the measure of current is quite noisy and the previous strategy may not be fully efficient. This is particularly true when current is near 0. The operation is always safe because the deadtime is always respected. However, the energy injected may be lower than expected because of bad measure of current direction.

In a Field Oriented Control modulation architecture (FOC), the Park transform provides Id/Iq information that is the reflect of the motor phase current. This information is much more stable because of the regulation. So, using Id/Iq information instead of motor phase current measure actually gives better efficiency of the dead-time compensation strategy.

Note that the considerations on how to use in a smart way the various measurement sources of current information (in the transistor pairs or legs and/or the battery or ground lines) and/or computed sources (from the modulation) and combinations thereof made for the dead-time compensation approach, equally applies for their use for additional safety blocks as outlines in FIG. 8 either said smart way of use is done for said safety block as such or for both the dead-time compensation block and the safety block.

In summary a (electric) motor based arrangement is provided, comprising: (1) an (electric) motor; (2) an (electric) motor power control means, provided for controlling said (electric) motor; (3) a first (digital) control unit, adapted for providing first control signals for said (electric) motor power control means; (4) a first (current (direction)) sensor adapted for determining information related to the power exchange between and said (electric) motor and said (electric) motor power control means; (5) a second control unit or system, wherein said second control unit is adapted for passing said first control signals, received from said first (digital) control unit, to said (electric) motor power control means in a first mode and adapted for providing second control signals for said (electric) motor power control means in a second mode and wherein said second control unit inputs and exploits said information, wherein said (electric) motor power control means comprises a plurality of (pair wise) serial connected switches (or transistors).

The arrangement organizes independent deadtime management per leg or serial connected switches.

The effect (on the energy) that we like to achieve is that it is important is to preserve the “I” pulse duration, because it control the current that flows to motor. Here we want to inject the expected current. As the “0” pulse does not carry current to the motor, consequently if the “0” pulse duration is changed it does not impact the motor control. The system does not care about the “0” pulse duration if it is slightly changed for the deadtime.

1. A method for improved energy injection to an electric motor, comprising:
(i) receiving transistor gate signals for at least one set of serially connected transistors;
(ii) determining, for said transistors, which transistors will inject energy to the motor and which transistors will not; and
(iii)(a) providing to said transistors which shall inject energy to the motor, the transistor gate signal as is; and
(b) providing to the other transistors the transistor gate signal with dead-time compensation; and
(iv) returning to step (i).

2. The method of claim 1, wherein the determining which transistors will inject energy to the motor and which transistors will not is based on information determined from the motor.

3. The method of claim 2, wherein the determining which transistors will inject energy to the motor and which transistors will not is based on measuring the current flow.

4. The method of claim 3, wherein the determining which transistors will inject energy to the motor and which transistors will not is based on estimating the current flow from information provided by the modulation method used for determining the received transistor gate signals.

5. The method of claim 3, further comprising, prior to step (i), selecting whether said determining is based on selecting either measuring of the current flow or estimating the current flow from information provided by the modulation method used for determining the received transistor gate signals.

6. The method of claim 3, wherein a difference between the estimated and measured current flow is used to indicate safety issues.

7. An arrangement, comprising:
(i) a digital logic circuit, generating transistor gate signals in accordance with a modulation method;
(ii) an inverter; and
(iii) a motor controlled by said inverter, characterized in that said arrangement is adapted to:
(a) provide to the transistors that will inject energy to the motor the transistor gate signal as is; and
(b) provide to the other transistors the transistor gate signal with dead-time compensation.

8. The arrangement of claim 7, further comprising:
(iv) a system, configured to receive said generated transistor gate signals as input and outputting transistor gate signals, whereby said inverter is controlled by the system outputted transistor gate signals, and wherein said system (a) provides to the transistors within said inverter that will inject energy to the motor, the transistor gate signal as is and (b) provide to the other transistors the transistor gate signal with dead-time compensation.

9. The arrangement of claim 7, wherein sensor circuitry to measure current is provided and said circuitry provides said information.

10. The arrangement of claim 7, wherein said information is provided by said digital logic circuit.

11. The arrangement of claim 9, further comprising an analog-to-digital convertor to digitize said information from the sensor circuitry.
